(19) United States
(12) Patent Application Publication
(10) Pub. No.: US 2020/0056946 A1
(43) Pub. Date: Feb. 20, 2020

(54) THERMAL DETECTION SYSTEM AND METHOD

(71) Applicant: SIGNIFY HOLDING B.V., EINDHOVEN (NL)

(72) Inventor: Hong CHEN, EINDHOVEN (NL)

(21) Appl. No.: 16/603,737

(22) PCT Filed: Apr. 9, 2018
(86) PCT No.: PCT/EP2018/058985

§ 371 Date: Oct. 8, 2019

(30) Foreign Application Priority Data
Apr. 11, 2017 (CN) PCT/CN2017/080091
Jun. 12, 2017 (EP) 17175429.4

(51) Int. Cl. G01K 7/32; G01K 1/02; G01K 15/00

(52) U.S. Cl. CPC G01K 7/32; G01K 2217/00; G01K 15/005; G01K 1/024

(57) ABSTRACT

A temperature sensing device is provided for sensing a temperature of a second device. A thermal detection signal is provided with a first clock frequency, and an electronic signal based on a second clock frequency, lower than the first clock frequency, is received from the second device. A time duration is measured between timing instants of the thermal detection signal and the electronic signal, and from an analysis of a set of measured time durations, a temperature at the second device is determined, based on knowledge of the frequency-temperature characteristics of the electronic signal.

### FIELD OF THE INVENTION

The invention relates to temperature detection for example for electronic circuits, and in particular relates to thermal detection without the need for a dedicated thermal probe or sensor.

### BACKGROUND OF THE INVENTION

In many different circuits, the circuit temperature is a key factor for system health. One particular example is lighting circuits, where the lighting elements generate significant amounts of heat as well as the desired light output. Thermal information is increasingly important in lighting circuits because many more semiconductor components and other electronics components are used in lighting systems, such as LED luminaires and lighting controllers.

Currently, most thermal detectors are based on a thermal coupler or thermal resistor and relevant circuitry, in order to measure the temperature. Infrared radiation cameras are also known for this purpose for providing a non-contact measurement option. These solutions are mature but not simple enough and cost effective in cost sensitive products like luminaires. The required complex circuits may also cause potential reliability risks.

It is known that a crystal oscillator, for example as used to generate a microcontroller clock signal, has a temperature dependency of its output frequency. This means the oscillator response may be used to determine temperature without the need for a separate temperature sensor. It is for example known to compare a frequency of one crystal oscillator with another crystal oscillator which has a different dependence on temperature, in order to determine temperature information. One example of this approach is disclosed in U.S. Pat. No. 9,228,906.

This requires particular types of crystal oscillator as well as accurate measurement of frequency. This measurement becomes increasing difficult for crystal oscillators with low dependency of their output frequency on temperature. As a result, crystals with a high temperature dependency are needed, but this is against the general aim of having a frequency response which is independent of temperature.

There is therefore a need for a more simple and flexible solution for thermal detection and which does not require the general temperature stability of the circuit to be compromised.

### SUMMARY OF THE INVENTION

The invention is defined by the claims.

Examples in accordance with a first aspect of the invention provide a temperature sensing device for sensing a temperature of a second device, comprising:
a controller which is adapted to:
   provide a thermal detection signal having a first clock frequency;
   receive an electronic signal based on a second clock frequency, lower than the first clock frequency, from the second device;
   measure a time duration, as a number of cycles of the thermal detection signal, between an edge of the thermal detection signal at a predetermined instant in time and a next detected edge of a predetermined type of the electronic signal; and
   from an analysis of a set of measured time durations, determine a temperature at the second device based on knowledge of the frequency-temperature characteristics of the electronic signal.

This device determines a temperature at a second device by measuring a time duration associated with an electronic (data communication) signal received from the second device, which in particular includes a variable delay resulting from different clocking frequencies. The electronic signal is a digital signal having a particular bit frequency which results from the second clock frequency. By measuring a set of time durations between signal edges, it becomes possible to measure time duration values resulting from very small changes in crystal oscillator frequency and hence second controller clock frequency. The temperature measurement may be implemented digitally. The second device is “second” for example in the sense that it is exposed to a different temperature environment, so that heating caused by the second device does not result in corresponding heating of the temperature sensing device.

The approach does not need modification to the hardware or software of the second device, since it simply relies on receipt of electronic (data) signals by the temperature sensing device from the second device. The thermal status of the second device is thus determined without any change in the existing product, in particular with no additional thermal sensor and associated circuits. The temperature sensing function is instead implemented based on analysis of a received data communication signal (which is generally termed an “electronic signal”) and statistical analysis.

The second device could be a remote device away from the temperature sensing device. In an example of outdoor lighting system, the second device is in a luminaire and the temperature sensing device is in cabinet.

In another example of outdoor lighting system, the second device is a part of a luminaire and the temperature sensing device is also a part of the luminaire. The second device is a driver board of the light sources, e.g. LEDs. The temperature sensing device is in a control board of the luminaire. The driver board is close to the light sources and it has higher power consumption. It causes worse working condition in temperature. The control board is relatively less closer to the light sources and it has less power consumption.

The electric signal is for example PWM signal for powering light sources. PWM signal is based on a dedicated PWM chip. The frequency of PWM signal is specified in the chip datasheet.

The controller is for example adapted to measure the time duration as the number of cycles of the thermal detection signal, rounded up to the next whole number, between a rising edge of the thermal detection signal at a predetermined instant in time to a next detected rising edge of the electronic signal.

The predetermined instant in time for is for example periodic. For example, every N cycles of the thermal detection signal, a time duration measurement is made from the beginning of that cycle to the next rising edge of the electronic signal. The time measurements may instead be based on the falling edges.

The device preferably comprises an address decoder to enable identification of the source of the electronic signal.

The electronic signal of interest is one received from a second device for which the temperature is being determined. The address decoder enables the relevant signals on a communications interface to be identified. The device may also have an impedance matching system so that the detection does not provide signal interference.

The set of measured time durations may comprise only time durations corresponding to at most two bit periods of the electronic signal. This simplifies the data analysis. For example if a rising edge is being used as the measurement point in the electronic signal, the bit transitions in the electronic signal which will be taken into account will form a data pattern of 01, 001 or 101. Thus, a 01 transition is identified which happens either immediately (i.e. the electronic signal had a value 0 at the predetermined instant, then transitioned to a 1 at the next bit period) or after only one bit delay (i.e. the electronic signal had a 10 or 00 transition followed by the 01 transition). In a typical embodiment, only data pattern 101 is taken into account.

The temperature is for example obtained based on a statistical analysis.

The statistical analysis may comprise:
a calculation of a mean value or any other value of the time durations or functions thereof; or
an analysis of a distribution or any other spread of the time durations or functions thereof.

These different possible analyses of the time durations may be used to assess the temperature of the second device, optionally via intermediate determination of the clock frequency of the second device.

The device may comprise a lighting system controller. Only a small software update is needed in the controller to implement the method.

The invention also provides a temperature sensing system, comprising:
a temperature sensing device as defined above; and
a second device connected to the temperature sensing device by a data communications interface.

The second device has a second controller which is clocked by a second crystal oscillator at the second clock frequency, for example an AT-cut quartz oscillator.

The temperature characteristics of the second crystal oscillator are known, so that the temperature dependency of the frequency of the electronic signal is known.

The second device may comprise a lighting load and associated local lighting controller.

The controller of the temperature sensing device may be adapted to implement a calibration measurement with the second device at one or more known temperatures. This calibration process thus provides a mapping between a change in time value (e.g. average time duration or other statistical value based on the measured time durations) and temperature (optionally via frequency as an intermediate calculation result).

Examples in accordance with another aspect of the invention provide a temperature sensing method, comprising:
generating a thermal detection signal at a first controller, the first thermal detection signal clocked by a first crystal oscillator;
receiving electronic signals from a second device, the electronic signals based on a second clock frequency, lower than the first clock frequency;
measuring a time duration, as a number of cycles of the thermal detection signal, between an edge of the thermal detection signal at a predetermined instant in time and a next detected edge of a predetermined type of the electronic signal; and
analyzing a set of measured time durations, thereby to determine a temperature at the second device based on knowledge of the frequency-temperature characteristics of the electronic signal.

This method measures a time delay between two signals, based on the number of cycles of the higher speed signal. This does not give an accurate measurement, since it is no more accurate than the period of the higher speed signal. However, by analyzing multiple such measurements, a much more accurate measurement is made possible which indicates a frequency of the electronic signal. This can then be converted to a temperature.

Determining the temperature is for example based on a statistical analysis which comprises a calculation of a mean value or any other value of the time durations or functions thereof or an analysis of a distribution or any other spread of the time durations or functions thereof.

The method may comprise, at a lighting system controller, sensing the temperature at a second lighting load. The invention may be implemented, at least in part, in software.

### BRIEF DESCRIPTION OF THE DRAWINGS

Examples of the invention will now be described in detail with reference to the accompanying drawings, in which:

FIG. 1 shows a network of a central control device and a set of second load devices;

FIG. 2 shows different crystal cuts;

FIG. 3 shows the frequency-temperature characteristics for different crystal cuts;

FIG. 4 shows a set of frequency-temperature characteristics for AT cuts of different angles;

FIG. 5 shows a frequency-temperature characteristic for a BT cut;

FIG. 6 shows a typical angle choice for an AT cut;

FIG. 7A shows a temperature sensing device 70 as a standalone system and FIG. 7B shows a temperature sensing device 70 formed as part of the central lighting controller;

FIG. 8 shows the elements of the temperature sensing device in more detail;

FIG. 9 shows a change of the bit period of a signal resulting from temperature changes;

FIG. 10 shows a conventional approach for measuring time durations;

FIG. 11 shows the timing approach used in the device and method of the invention;

FIG. 12 shows the results of circuit simulation of the method;

FIGS. 13A to 13D provide a simulation result of the measured time durations;

FIG. 14 shows a temperature sensing method;

FIG. 15 shows how the approach of the invention may be applied to a wireless signal; and

FIG. 16 illustrates an example of a computer for implementing the controller or processor used in the device.

### DETAILED DESCRIPTION OF THE EMBODIMENTS

The invention provides a temperature sensing system and method for sensing a temperature of a second device. A thermal detection signal is provided with a first clock frequency, and an electronic signal based on a second clock frequency, lower than the first clock frequency, is received from the second device. A time duration is measured between timing instants of the thermal detection signal and the electronic signal, and from an analysis of a set of measured time durations, a temperature at the second device is determined, based on knowledge of the frequency-temperature characteristics of the electronic signal.

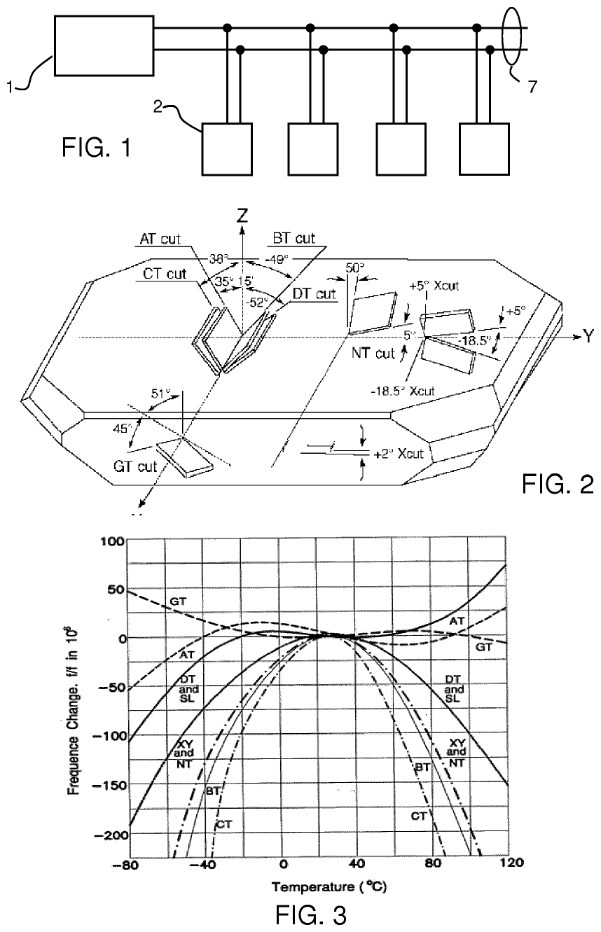

FIG. 1 shows a network of a central control device 1 and a set of second load devices 2. The central control device 1 controls and communicates with the second (load) devices 2 over a communication interface, in particular a bus 7.

In one example, the overall system is a lighting system, in which the central control device is a main (upstream) lighting controller and the second devices are luminaires.

The invention makes use of electronic signals on the bus 7 to determine the temperature at a second device 2. It does not require any particular design of second device or any particular communications protocol to be followed by the second device.

In a regular networked lighting system of this type, the upstream central control unit, such as segment controller, is an existing part of the system. By providing software code within the existing software, additional data processing functions may be realized.

As mentioned above, the crystal oscillator is key component in all microcontroller based digital systems, as it provides the periodic pulses for use as the microcontroller clock signal. All operations of the microcontroller are based on this signal. If the output of the crystal oscillator is changed, for example the frequency is increased, the operation of the microcontroller will be slightly faster than before. The speed will reduce when the frequency drops.

This invention is based on observing the frequency variance indirectly, by measuring time delay periods. Temperature is one variable which affects the output frequency of the crystal, so that temperature can be derived by measuring variance of these delay periods.

There are three main factors which have an impact on the output of a crystal oscillator. These are the capacitance of the load, the excitation power and temperature.

In a typical application, the load capacitance and excitation power for the crystal oscillator are determined by the electrical circuit. Thus, these two factors will not affect the crystal oscillator frequency once the hardware is fixed. Therefore, the temperature dependency remains the only significant cause for frequency variation.

Different crystal oscillators have different frequency-temperature (f-T) curves. The f-T characteristics are strongly related to the process by which crystals has been cut from a quartz sheet.

FIG. 2 illustrates the different cutting processes, including AT, BT, CT, DT, GT and NT cuts. Different cutting methods cause different f-T curves as shown in FIG. 3, which shows frequency versus temperature.

The frequency-temperature characteristics of the crystal are categorized into two types according to its shape of curve. One is a tertiary curve and the other is a quadratic curve.

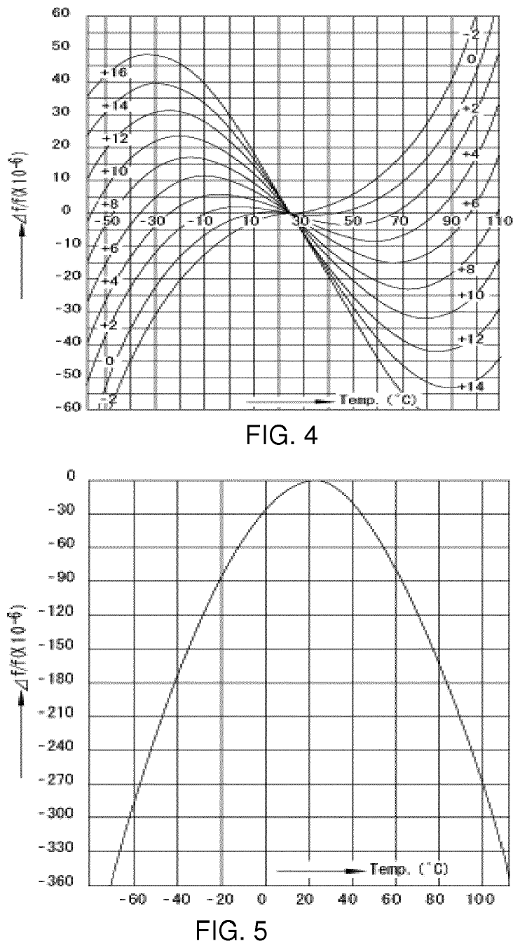

The typical frequency-temperature characteristics of AT and BT cuts are shown in FIGS. 4 and 5, respectively. The set of curves shown in FIG. 4 depend on the angle of the cut so that the angle at which the quartz plate is cut from a quartz bar determines the frequency vs. temperature characteristics of a crystal unit.

AT cut crystal units are most widely used because they produce smaller frequency changes in response to temperature changes in the room temperature range. The change in frequency follows a series of 3rd degree S-Curves as shown in FIG. 4.

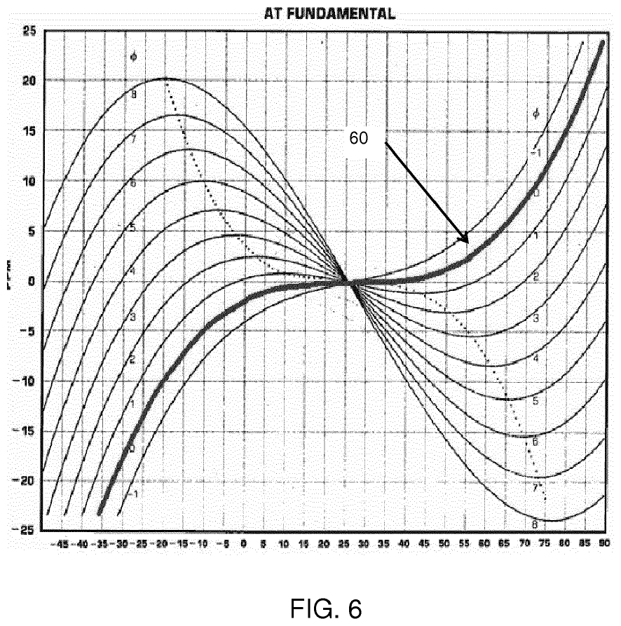

Adjustment of the cut angle allows the crystal design engineer to select the desired temperature coefficient for the application. To get best frequency stability at a room temperature range, a particular cut angle is used. As shown in FIG. 6, the proper cut-angle gives the bold line 60 which is flat around 20 degrees. This corresponds to the most popular cut-angle for a crystal oscillator. The resulting curve is a monotone increasing function.

There is a clear mathematical expression for the temperature-frequency function of an AT-cut crystal oscillator, which is provided by the manufacturer. A typical example is:

$$\frac{Δ f}{{f}_{0}} = {a}_{0} ( T - {T}_{0} ) + {{c}_{0} ( T - {T}_{0} )}^{3}$$

T₀ is reference temperature;
f₀ is frequency at temperature T₀;
a₀ is a temperature coefficient of the fundamental;
c₀ is a temperature coefficient of the 3rd overtone.

In the system of FIG. 1, the upstream controller 1 may be considered to be in a constant temperature environment, such as room temperature. The microcontroller and crystal have the best frequency stability. Thus, each machine cycle has the same time expense with no frequency variance according to the corresponding temperature-frequency curve.

The luminaires 2 work in a practical environment which means the temperature changes according to different working conditions. For example, when the luminaire is working, the power dissipation will heat the whole luminaire including the control board which includes the crystal oscillator especially for a compact LED luminaire in which the LED driver (control board) is integrated with or very close to the LEDs. This leads to a frequency change which follows the known curve. The speed of the microcontroller changes accordingly. Thus by detecting the temperature of the crystal oscillator on the driver board, the status of the LED can be monitored. Of course, the temperature of the drivers could also be affected by other factors, such as the lighting system being in an abnormal condition, etc. By detecting the temperature of second luminaires, a health condition of the luminaires can be obtained.

When the same program is run by the microcontroller, the time expense is different from before. Based on the known frequency-temperature function, the accurate temperature change can be derived based on time differences.

It is challenging to measure directly a time difference at different temperatures because the frequency variance is very small. Usually for an AT cut crystal, the variation is ±25 ppm for a temperature range of −55° C. to +85° C.

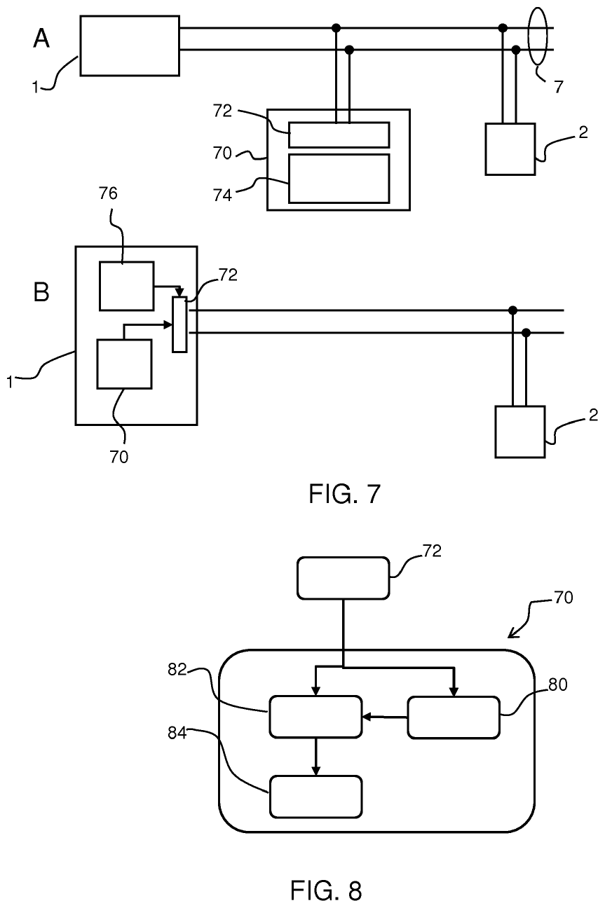

The invention provides a temperature sensing device which makes use of analysis of electronic signals generated by the second device, and hence at the clock frequency of the oscillator in the second device. The temperature sensing system may be part of the central control device 1 or it may be an independent device. These two options are shown in FIG. 7.

FIG. 7A shows the temperature sensing device 70 as a standalone system. It comprises a communication interface 72 which is connected to the communication bus 7. The sensing device 70 works in a passive mode, in that that it just listens to the electronic data signals on the bus 7 and analyzes the digital signals (from the luminaire 2) but does not need to send any signals on the bus. A thermal measurement microcontroller 74 performs the temperature measurement calculations, which are explained below.

FIG. 7B shows the temperature sensing device 70 formed as part of the central controller 1. In this case, source code is embedded into the upstream controller 1 without any need for hardware alteration. The main controller functionality is unchanged, and is represented by block 76. There is again a communications interface 72 which is part of the existing central controller hardware.

FIG. 8 shows the elements of the temperature sensing device 70 in more detail. The communications interface 72 receives the electronic signal, which is a digital data communications signal provided on the bus 7. It comprises a series of binary bit values in succession at a clock frequency. The signal is provided to an address decoder 80 and to a timer 82. The timer makes use of a local clock signal which functions as a thermal detection signal, and timing measurements are made between signal edges. The timing information is provided to a microcontroller 84 which performs the thermal calculations, as well as implementing an optional calibration routine.

As explained above, the timing of the electronic (data communication) signal generated by a lighting unit is based on, and hence closely related to, the original clock signal. Thus, the frequency of the electronic signal will change slightly when the oscillator is working at a different ambient temperature.

FIG. 9 shows a change of the bit period of a signal from t1 to t2 which may result from temperature changes. By measuring the signal frequency or period, the temperature can be deduced based on a mathematic model of the crystal temperature characteristics, as explained above.

The challenge is how to measure the variance of the signal period with sufficient accuracy. The time variance of the electronic signal caused by thermal changes is very small (usually a few nanoseconds). If a very high resolution timer is used, the cost is very high. For example, a GHz timer would be required if a conventional method for time measurement is used.

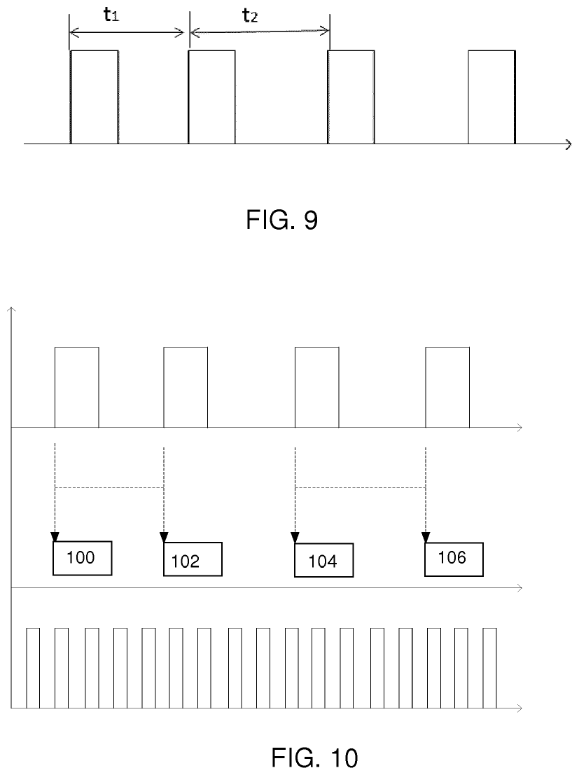

This conventional approach is shown in FIG. 10. The top plot shows the electronic signal. The middle plot show the timing instants, wherein the timer is started at instant 100 and stopped at instant 102, then started again at instant 104 and stopped at instant 106. The bottom plot shows the timer clock signal. The timer can only measure time intervals with an accuracy corresponding to its clock signal period. Thus, the frequency needs to be very high (much higher than schematically represented in FIG. 10) if small variations in the period of the electronic signal are to be measured.

The temperature sensing device 70 of FIGS. 7 and 8 instead may use a low end microcontroller. The timer 82 and microcontroller are used to measure the variance of the signal frequency indirectly. Although the signal variance is at the nanosecond level, the need for a very high frequency clock (gigahertz) for the timer is avoided.

The timer does make use of a clock signal which is faster than the clock signal used in the lighting units to generate the electronic signal. However, the timer clock only needs to be a small multiple faster than the signal clock associated with the electronic signal. For example, the timer may have a clock frequency of 300 kHz for an electronic signal based on a (standard) 115.2 kHz clock. A higher timer clock frequency may be used, but this is not essential. For example, considering the cost of high frequency timer, the timer clock will generally be in the range of 2.5 to 10 times the frequency of the signals on the communications bus 7.

A simple communications interface 72 is used to monitor the signal on the bus 7 and it operates only in a listening mode. It includes impedance matching to avoid signal interference when the temperature sensing device detector is connected to the communications bus 7, and it also includes address decoding. The bus 7 carries bidirectional communication signals and signals to and from multiple second devices. The signals on the bus are thus screened making use of the address decoder 80 so that signals can be ignored from other devices than the second device being monitored.

To measure the time variance of the electronic signal, an algorithm based on probability and statistic theory is used.

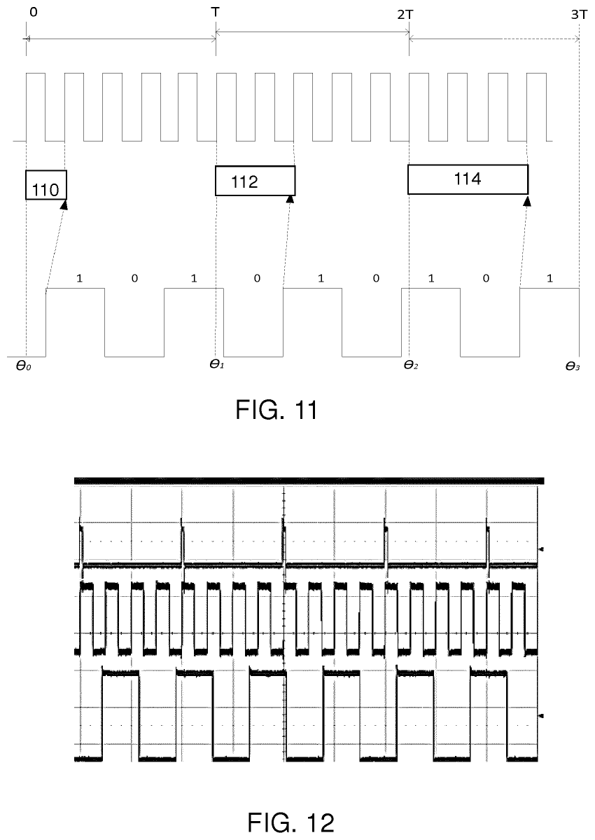

FIG. 11 shows the timing approach used in the device and method of the invention.

The top plot shows the timer signal. This timer signal may be considered to be a thermal detection signal, having a first clock frequency.

The bottom plot shows the received electronic signal. It is based on a second clock frequency, lower than the first clock frequency, and is generated in the second device. The thermal detection signal should not be synchronized with the electronic signal. In this example, the thermal detection signal has a frequency just under three times the frequency of the electronic signal.

The timing duration measurements start at an edge of the thermal detection signal, at a predetermined instant in time. In the example shown, the timing duration measurements start at a rising edge of the thermal detection signal, and there is a new time duration measurement starting every 5 periods of the thermal detection signal. The time value T corresponds to this 5 time cycle period duration. Of course, the delay between measurements may be a larger or smaller number of cycles. This will depend on the relative speeds of the clock signals. In particular, the time period between measurements needs to be long enough for the measurement to take place.

The time duration measured is from the rising edge of the thermal detection signal to the next rising edge of the electronic signal.

In the first measurement cycle (from 0 to T) the next rising edge of the electronic signal is almost immediate. Thus, after the first thermal detection signal cycle, the rising edge has been detected, and the timed period 110 is 1 cycle. Thus, it can be seen that the time duration is measured as a number of cycles of the thermal detection signal.

In the second measurement cycle (from T to 2T) there is first, and almost immediately, a falling edge of the electronic signal, so the next rising edge of the electronic signal is delayed. In this case, after the second thermal detection signal cycle, the rising edge has been detected, and the timed period 112 is 2 cycles.

In the third measurement cycle (from 2T to 3T) there is again first a falling edge of the electronic signal but after some delay, so the next rising edge of the electronic signal is further delayed. In this case, after the third thermal detection signal cycle, the rising edge has been detected, and the timed period 114 is 3 cycles.

The different time periods result from different phases of the electronic signal θ0, θ1, θ2 . . . at the timer starting instants 0, T, 2T, 3T, etc. Because the signals are non-synchronous, the phases θ0, θ1, θ2, etc. are different. If the timer is started at rising edge of an arbitrary pulse signal, the phase θ can be take value within range of [0,360° ] according to probability theory.

From an analysis of a set of measured time durations, a temperature at the second device can be derived based on knowledge of the frequency-temperature characteristics of the electronic signal.

It is noted that measured of the time durations can also be done by voltage sampling of the electronic signals and count the cycles to data pattern 01, i.e. from the rising edge of the thermal detection signal to the next rising edge of the electronic signal.

The possible number of cycles in the timed period depends on the timer clock frequency. As mentioned above, the timer clock will generally be in the range of 2.5 to 10 times the frequency of the signals on the communications bus 7. A higher timer clock frequency may be desired, but there is a higher cost. Similarly, a lower timer clock frequency may be used, for example down to 1.1 times the frequency of the signals on the communications bus 7. This will give only two possible measurement results so that a larger data set may be required.

One preferred arrangement provides three possible measurement results (i.e. 1, 2 or 3 cycles). The number of possible measurements is given by N=roundup(f_up/f_down), where f_up is the frequency of upstream controller, and f_down is the frequency of downstream unit.

FIG. 12 shows the results of a circuit simulation of the method. The top plot shows timer start instants (0, T, 2T, etc.), the middle plot shows the thermal detection signal (i.e. the faster clock signal) and the bottom plot shows the electronic signal.

By repeating the timer operation typically hundreds or thousands of times, a statistic data set {N} is obtained. The number of occurrences of a time period of 1 cycle, 2 cycles, etc. enables a distribution curve to be derived. When the period of the electronic signal is changed slightly due to thermal effects, the distribution curve will change as well.

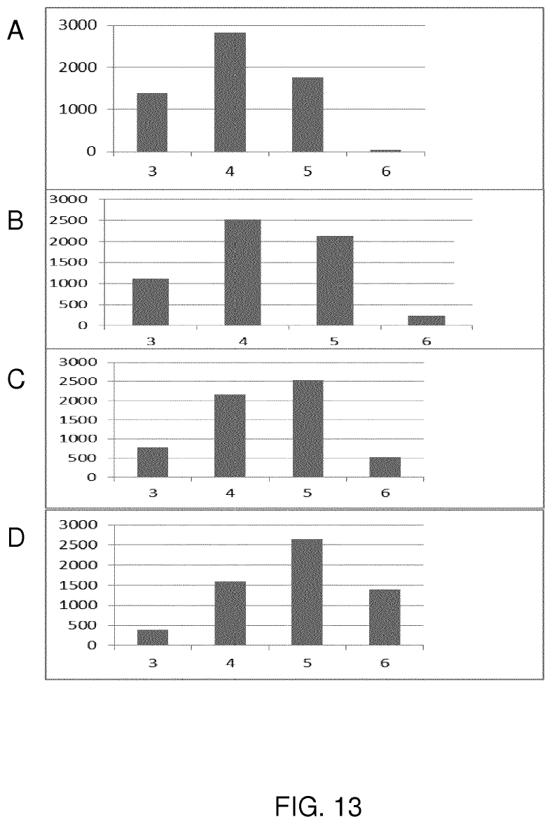

FIGS. 13A to 13D provide a simulation result. They show different distributions of delay periods for different temperatures of the second unit, giving rise to a reducing clock frequency. According to the distribution information and the frequency-temperature characteristics of the crystal in the second device, the temperature can be deduced.

Note that there is some time penalty for operation in a real system in detecting edges and measuring the time periods. FIG. 11 shows an idealized representation which assumes the timer can start counting immediately. However, in the simulation of FIG. 13, there is a 2 cycle delay when the timer is starting. Thus, although the timer readout is still 1 cycle for example, the real time expense is actually 3 clock cycles. Thus, in FIG. 13, the x-axis represents the real time expense based on clock cycles.

The analysis of the measured time durations, and their distribution in particular, comprises a statistical analysis, such as for example a calculation of a mean value or any other value of the time intervals or functions thereof or such as for example an analysis of a distribution or any other spread of the time intervals or functions thereof.

As can be seen from the example above, the greater the number of time intervals recorded, the more information is obtained from the distribution. By performing analysis of a number of time intervals, the frequency of operation of the second device can be determined much better. The number of time duration measurements is at least ten, preferably at least one hundred. There may even be 1000 or more measurements.

Clearly, from FIG. 13A to FIG. 13D, the distributions are shifting to the right. For the time intervals related to FIG. 13A, a calculation of a mean value of the time intervals will result in a smaller value than a similar calculation for the time intervals related to FIG. 13B and so on. The distribution or any other spread of the time durations may be used for analysis.

FIG. 11 shows an electronic signal in the form of a simple periodic signal (10101010 . . . ). In a real application, the signal is different. It may comprise any bit sequence, such as 1010011001. When the timer is working in this scenario, the timer output may be an extremely high value, if waiting for the next 01 transition. The thermal calculation results will then be corrupted by this data.

To address this problem, the controller can monitor the electronic signal and make a judgement as to which time duration measurements are taken into account. For example the time duration measurements may be kept only for data patterns in the electronic signal of “101”, “001” or “01” (101 and 01 are shown in FIG. 11). This means that the next 01 transition is at most two bit periods away (of the electronic signal) from the starting time. Thus the range of values of the time duration is 1 to N where N is the ratio between the clock frequencies of the thermal detection signal and the electronic signal (rounded up to the nearest integer). For example, for FIG. 11, only time durations 1, 2 and 3 are then possible. The time expense values (as shown in FIG. 13) are then from M to N+M where M is the number of cycles needed to start the timer.

The higher the value of N, the higher the resolution of the distribution plot. However, with large numbers of measurements, even a low ratio (such as near to 3) enables accurate temperature determination.

Even if very small changes in timing are caused by temperature changes, the can be detected. For example, if 1000 timing measurements are taken at temperature Ta, the frequency density of the timing measurements may be as shown below:

Timer readout

| | 1 | 2 | 3 |
|---|---|---|---|
| Frequency | 100 | 800 | 100 |

If the temperature is changed by a small amount to Tb the data from the timer may only affect a small number of values as shown below:

Timer readout

| | 1 | 2 | 3 |
|---|---|---|---|
| Frequency | 95 | 803 | 102 |

These changes may result from nanosecond changes in the period of the electronic signal, since it only takes nanosecond delays for a signal edge of the electronic signal to cross the timing instant of an edge of the thermal detection signal.

This provides a shift to the increasing values, for example as shown in FIG. 13. The readout is still within the range 1 to 3 but the change in distribution reflects the change in temperature. For example, the average value changes from 2.000 to 2.007.

A calibration stage may also be carried out.

As a minimum, a calibration may take place at a known temperature. However, a calibration may involve taking measurements at two known temperatures; T1 and T2.

At each calibration temperature, a distribution of time durations is obtained. The determined crystal frequency at the known temperature or temperatures is obtained from the frequency-temperature curve and from the formula for the crystal oscillator.

A function can then be fit to the two values of the distribution (i.e. the metric which is derived from the distribution, such as the mean or a measure of spread or a combination thereof). The calibration process then enables a mapping to be provided between a time duration metric and temperature.

Note that the mapping may not need to actually calculate the frequency. However, the calibration then is based on knowledge of the frequency-temperature characteristics of the electronic signal (i.e. the second oscillator).

The calibration may be based on interpolation/extrapolation between two calibration temperatures T1 and T2. From calibration measurements, a representative time value (such as an average) is calculated for each temperature; t_ref1 and t_ref2. The determined crystal frequencies f1 and f2 at the two temperatures T1 and T2 are obtained from the frequency-temperature curve and from the formula for the crystal oscillator.

A reference time value and corresponding reference frequency value may then be obtained:

t_ref=t_ref2−t_ref1

f_ref=f2−f1

This calibration process thus provides a mapping between a change in time delay and a change in frequency. The change in time value becomes a reference time value and the change in frequency becomes a reference frequency value. By deriving change values as the references, it becomes possible to compensate for any constant time interval contributions.

After the calibration, the system is ready for use.

This involves performing a temperature measurement, namely when there is an unknown temperature Tx at the downstream side.

A new time value is obtained t_measured.

A time difference is then calculated as tx=t_measured−t_ref1.

A frequency difference is then obtained as fx=tx/t_ref*f_ref.

This sets the ratio of the measured frequency to the reference frequency value as equal to the ratio of the measured time interval to the reference time value. In other words, it is based on a linear relationship between the time interval and the frequency.

The frequency of the crystal at the unknown temperature is then obtained as

f=fx+f1

This is a linear interpolation or extrapolation from the two measurements at known temperature. According to the frequency temperature curve of crystal and the formula for the crystal oscillator, the temperature Tx can be derived.

There may be a direct mapping between the time duration metric and the temperature, or else there may be an intermediate determination of frequency, which is then converted to temperature based on the known temperature-frequency characteristics.

Although the clock frequency of the thermal detection signal is higher than the clock frequency of the electronic signal, it still does not have enough resolution to measure (i.e. see) the time difference caused by temperature changes.

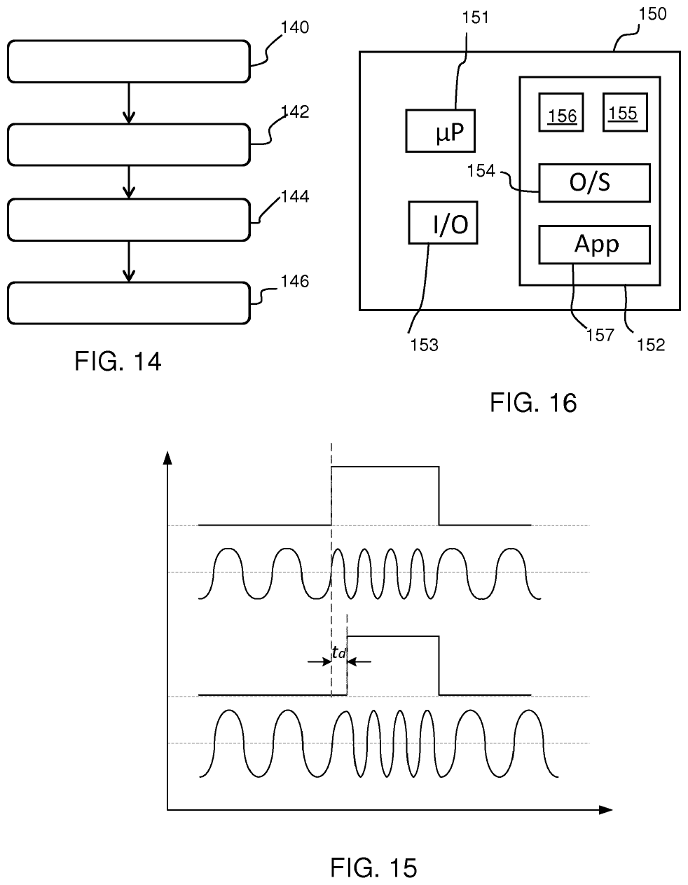

FIG. 14 shows a temperature sensing method.

In step 140, a thermal detection signal is generated at a first controller, the first thermal detection signal clocked by a first crystal oscillator.

In step 142, electronic signals are received from a second device, the electronic signals based on a second clock frequency, lower than the first clock frequency.

In step 144, a time duration is measured, as a number of cycles of the thermal detection signal, between an edge of the thermal detection signal at a predetermined instant in time and a next detected edge of a predetermined type of the electronic signal.

In step 146, a set of measured time durations is analyzed, thereby to determine a temperature at the second device based on knowledge of the frequency-temperature characteristics of the electronic signal.

The method may include a calibration step in which the second device is known to be at a particular temperature or set of temperatures such as room temperature and/or one or more regulated known temperature. This provides reference information for calibrating the subsequent temperature measurements.

The invention has been described above in connection with a wired system. However, the same concepts may be applied to a wireless system. In particular, any system in which an incoming signal undergoes a frequency dependent time delay may make use of the approach described above.

By way of example, a wireless signal may make use of frequency modulation. The signal modulation will not cause any loss in the time domain, whereas a clock frequency change will alter the timing and duration of the original pulse signal which is used to generate the modulation carrier signal. Thus, after demodulation at the receiving side, all information in the time domain relating to the original carrier signal can be recovered.

In another example of outdoor lighting system, the second device is a part of a luminaire and the temperature sensing device is also a part of the luminaire. The second device is a driver board of the light sources, e.g. LEDs. The temperature sensing device is in a control board of the luminaire. The driver board is close to the light sources and it has higher power consumption. It causes worse working condition in temperature. The control board is relatively less closer to the light sources and it has less power consumption.

The electric signal is for example PWM signal for powering light sources. PWM signal is based on a dedicated PWM chip. The frequency of PWM signal is specified in the chip datasheet and the frequency value of PWM signal depends on peripheral RC circuits. Normally temperature impacts value of capacitances more than the value of resistors, i.e. capacitors have higher excursion with temperature than other components. Hence according to temperature-capacitance relationship of capacitor, measured frequency shift of the PWM signal obtained according above way, the temperature of capacitor can be obtained.

The top two plots of FIG. 15 show a frequency modulated wireless signal, comprising the original carrier signal (which conveys the data pattern) and the frequency modulated resulting signal. The bottom two plots show the signal after reception with a delay which results from a change in the frequency of the clock signal used to encode the bit pattern. This bit pattern (the carrier signal) can be analyzed using the approach as described above.

The system described above makes use of a controller/processor for processing data to determine the temperature.

FIG. 16 illustrates an example of a computer 150 for implementing the controller or processor described above.

The computer 150 includes, but is not limited to, PCs, workstations, laptops, PDAs, palm devices, servers, storages, and the like. Generally, in terms of hardware architecture, the computer 150 may include one or more processors 151, memory 152, and one or more I/O devices 153 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 151 is a hardware device for executing software that can be stored in the memory 152. The processor 151 can be virtually any custom made or commercially available processor, a central processing unit (CPU), a digital signal processor (DSP), or an auxiliary processor among several processors associated with the computer 150, and the processor 151 may be a semiconductor based microprocessor (in the form of a microchip) or a microprocessor.

The memory 152 can include any one or combination of volatile memory elements (e.g., random access memory (RAM), such as dynamic random access memory (DRAM), static random access memory (SRAM), etc.) and non-volatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 152 may incorporate electronic, magnetic, optical, and/or other types of storage media. Note that the memory 152 can have a distributed architecture, where various components are situated second from one another, but can be accessed by the processor 151.

The software in the memory 152 may include one or more separate programs, each of which comprises an ordered listing of executable instructions for implementing logical functions. The software in the memory 152 includes a suitable operating system (O/S) 154, compiler 155, source code 156, and one or more applications 157 in accordance with exemplary embodiments.

The application 157 comprises numerous functional components such as computational units, logic, functional units, processes, operations, virtual entities, and/or modules.

The operating system 154 controls the execution of computer programs, and provides scheduling, input-output control, file and data management, memory management, and communication control and related services.

Application 157 may be a source program, executable program (object code), script, or any other entity comprising a set of instructions to be performed. When a source program, then the program is usually translated via a compiler (such as the compiler 155), assembler, interpreter, or the like, which may or may not be included within the memory 152, so as to operate properly in connection with the operating system 154. Furthermore, the application 157 can be written as an object oriented programming language, which has classes of data and methods, or a procedure programming language, which has routines, subroutines, and/or functions, for example but not limited to, C, C++, C#, Pascal, BASIC, API calls, HTML, XHTML, XML, ASP scripts, JavaScript, FORTRAN, COBOL, Perl, Java, ADA, .NET, and the like.

The I/O devices 153 may include input devices such as, for example but not limited to, a mouse, keyboard, scanner, microphone, camera, etc. Furthermore, the I/O devices 153 may also include output devices, for example but not limited to a printer, display, etc. Finally, the I/O devices 153 may further include devices that communicate both inputs and outputs, for instance but not limited to, a network interface controller (NIC) or modulator/demodulator (for accessing second devices, other files, devices, systems, or a network), a radio frequency (RF) or other transceiver, a telephonic interface, a bridge, a router, etc. The I/O devices 153 also include components for communicating over various networks, such as the Internet or intranet.

When the computer 150 is in operation, the processor 151 is configured to execute software stored within the memory 152, to communicate data to and from the memory 152, and to generally control operations of the computer 150 pursuant to the software. The application 157 and the operating system 154 are read, in whole or in part, by the processor 151, perhaps buffered within the processor 151, and then executed.

When the application 157 is implemented in software it should be noted that the application 157 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

While the invention has been illustrated and described in detail in the drawings and foregoing description, such illustration and description are to be considered illustrative or exemplary and not restrictive; the invention is not limited to the disclosed embodiments.

This invention is applicable to automatic light network health monitoring, especially for wired lighting networks. However, the invention is applicable to other systems including internet of things systems.

The time durations measured may be between rising edges, between falling edges or between a rising edge then a falling edge or between a falling edge then a rising edge. These four possibilities do not change the underlying concepts.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A temperature sensing device for sensing a temperature of a second device, comprising:
a controller which is adapted to:
provide a thermal detection signal having a first clock frequency;
receive an electronic signal based on a second clock frequency, lower than the first clock frequency, from the second device;
measure a time duration, as a number of cycles of the thermal detection signal, between an edge of the thermal detection signal at a predetermined instant in time and a next detected edge of a predetermined type of the electronic signal; and
from an analysis of a set of measured time durations, determine a temperature at the second device based on knowledge of the frequency-temperature characteristics of the electronic signal.

2. The device as claimed in claim 1, wherein the controller is adapted to measure the time duration, as the number of cycles of the thermal detection signal, rounded up to the next whole number, between a rising edge of the thermal detection signal at a predetermined instant in time to a next detected rising edge of the electronic signal.

3. The device as claimed in any preceding claim, comprising an address decoder to enable identification of the source of the electronic signal.

4. The device as claimed in claim 1, wherein the set of measured time durations comprise only time durations corresponding to at most two bit periods of the electronic signal.

5. The device as claimed in claim 1, wherein the temperature is obtained based on a statistical analysis.

6. The device as claimed in claim 5, wherein the statistical analysis comprises:
a calculation of a mean value or any other value of the time durations or functions thereof; or
an analysis of a distribution or any other spread of the time durations or functions thereof.

7. The device as claimed in claim 1, comprising a lighting system controller.

8. A temperature sensing system, comprising:
a temperature sensing device as claimed in claim 1; and
a second device adapted to communicate with the temperature sensing device by a data communications interface.

9. The system as claimed in claim 8, wherein the second device has a second controller which is clocked by a second crystal oscillator at the second clock frequency.

10. A system as claimed in claim 8, wherein the second device comprises a lighting load and associated local lighting controller.

11. The system as claimed in claim 7, wherein the controller of the temperature sensing device is adapted to implement a calibration measurement with the second device at one or more known temperatures.

12. A temperature sensing method, comprising:
generating a thermal detection signal at a first controller, the first thermal detection signal clocked by a first crystal oscillator;
receiving electronic signals from a second device, the electronic signals based on a second clock frequency, lower than the first clock frequency;
measuring a time duration, as a number of cycles of the thermal detection signal, between an edge of the thermal detection signal at a predetermined instant in time and a next detected edge of a predetermined type of the electronic signal; and
analyzing a set of measured time durations, thereby to determine a temperature at the second device based on knowledge of the frequency-temperature characteristics of the electronic signal.

13. The method as claimed in claim 12, comprising determining the temperature based on a statistical analysis which comprises:
a calculation of a mean value or any other value of the time durations or functions thereof; or
an analysis of a distribution or any other spread of the time durations or functions thereof.

14. The method as claimed in claim 11, comprising, at a lighting system controller, sensing the temperature at a second lighting load.

15. The computer program comprising code means which is adapted, when said program is run on a computer, to implement the method of claim 11.
